(19) United States
(12) Patent Application Publication
(10) Pub. No.: US 2019/0206256 A1
(43) Pub. Date: Jul. 4, 2019

(54) MOTOR VEHICLE HAVING A SOUND CAPTURE DEVICE

(71) Applicant: Ford Global Technologies, LLC, Dearborn, MI (US)

(72) Inventor: Carsten Starke, Vaals (NE)

(73) Assignee: Ford Global Technologies, LLC, Dearborn, MI (US)

(21) Appl. No.: 16/213,028

(22) Filed: Dec. 7, 2018

(30) Foreign Application Priority Data
Jan. 2, 2018 (DE) 102018200008.5

(51) Int. Cl. G08G 1/16; G01S 11/14

(52) U.S. Cl. CPC G08G 1/167; G01S 11/14; G08G 1/168

(57) ABSTRACT

A motor vehicle having a sound capture device for the directionally dependent capture of external sound and providing an input signal representative of the external sound, an evaluation unit for evaluating the input signal and for providing an output signal representative of the input signal, and a loudspeaker assembly in the interior of the motor vehicle for outputting a sound signal consistent with the output signal.

### FIELD OF THE INVENTION

The present invention generally relates to motor vehicles, and more particularly relates to a motor vehicle having a sound capture device.

### BACKGROUND OF THE INVENTION

Motor vehicles, such as passenger vehicles having electric motors as a traction motor and trams, are becoming increasingly quieter and emit distinctly less sound. However, this results in it becoming ever more difficult for a motor vehicle driver to detect such quiet road users solely on the basis of their sound emissions if they are not located in the field of vision of the motor vehicle driver, but rather are located in a blind spot. This can lead to potentially dangerous situations in road traffic. It would be desirable to reduce or minimize such adverse situations.

### SUMMARY OF THE INVENTION

According to one aspect of the present disclosure, a motor vehicle is provided. The motor vehicle includes a sound capture device for directionally dependent capture of external sound and providing an input signal representative of the external sound, an evaluation unit for evaluating the input signal and for providing an output signal representative of the input signal, and a loudspeaker assembly in an interior of the motor vehicle for outputting a sound signal consistent with the output signal.

According to another aspect of the present disclosure, a motor vehicle is provided. The motor vehicle includes a sound capture device capturing directionally dependent external sound, an evaluation unit evaluating the captured external sound and providing an output signal representative of the captured external sound, and a loudspeaker assembly in an interior of the motor vehicle for outputting a sound signal based on the output signal.

According to a further aspect of the present disclosure, a sound system for a motor vehicle is provided. The sound system for a motor vehicle includes a sound capture device for capturing directionally dependent external sound and providing an input signal representative of the external sound, an evaluation unit for evaluating the input signal and for providing an output signal representative of the input signal, and a loudspeaker in an interior of the motor vehicle for outputting a directional sound signal consistent with the output signal.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a schematic top view depiction of an exemplary embodiment of a motor vehicle having a sound capture device and loudspeaker assembly; and

FIG. 2 is a block diagram further illustrating components of the motor vehicle shown in FIG. 1.

### DETAILED DESCRIPTION OF THE PREFERRED EMBODIMENTS

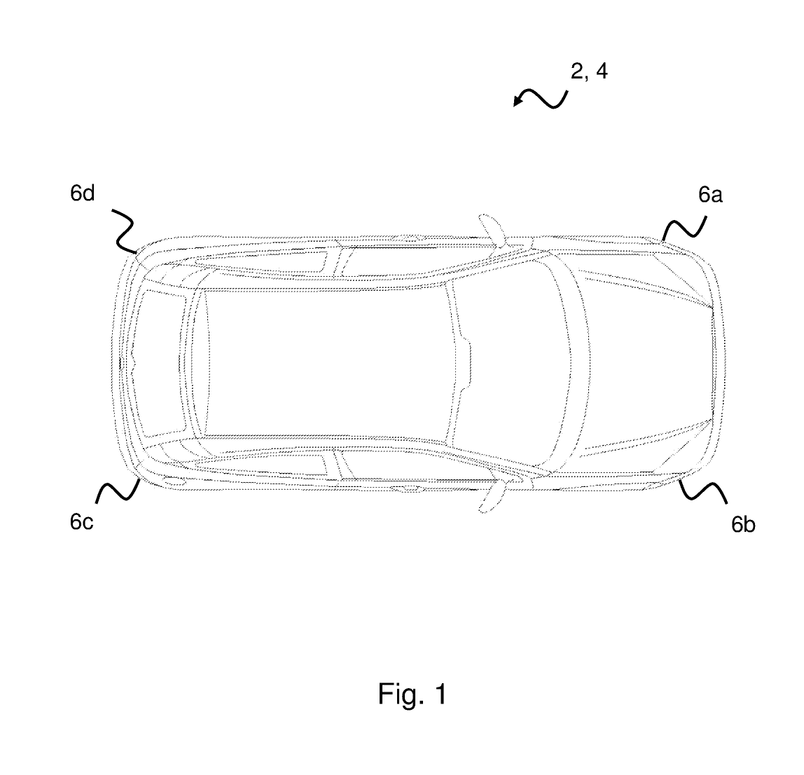

Reference will first of all be made to FIG. 1. The depiction is of a motor vehicle 2 shown in the present exemplary embodiment as a passenger vehicle. The motor vehicle 2 has a sound capture device 4 that can be used to receive sound from other road users, such as for example other motor vehicles, in directionally dependent fashion. To this end, the sound capture device 4 in the present exemplary embodiment has a plurality of microphones shown as four microphones 6a, 6b, 6c, 6d, of which one microphone 6a is arranged in the front left-hand corner, one microphone 6b is arranged in the front right-hand corner, one microphone 6c is arranged in the rear right-hand corner and one microphone 6d is arranged in the rear left-hand corner of the motor vehicle 2.

The arrangement of the microphones 6a, 6b, 6c, 6d allows sound propagation time difference measurements to be used to perform sound direction determination, such that it is possible to determine the direction from which the sound comes. As such, the direction information obtained in this manner can be used to infer a position of another road user.

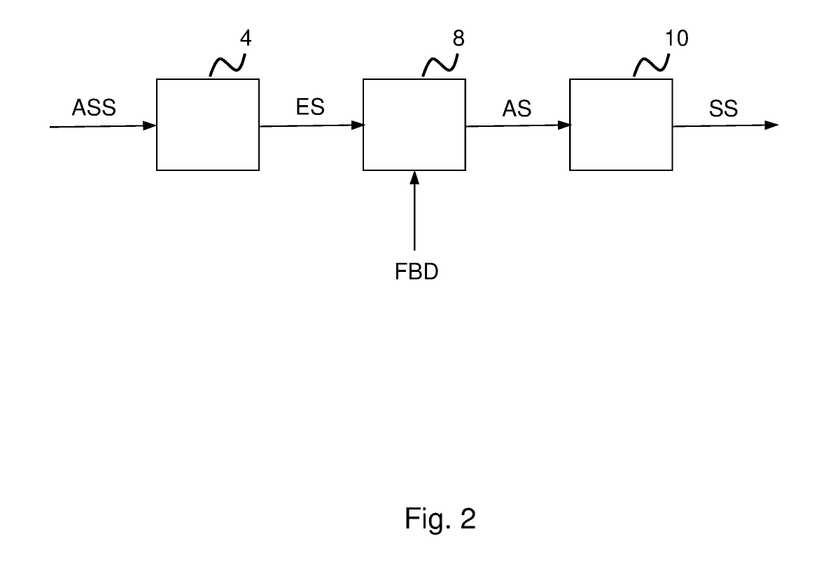

To this end, the motor vehicle 2 has further components, which will be explained with additional reference to FIG. 2. The depiction is of, besides the sound capture device 4, an evaluation unit 8 and a loudspeaker assembly 10. For the tasks/functions described below, the evaluation unit 8 may in particular have hardware and/or software components.

The sound capture device 4 is configured for directionally dependent capture of external sound ASS outside the motor vehicle 2. Further, the sound capture device 4 provides an input signal ES representative of the external sound ASS. The input signal ES reproduces a three-dimensional sound map of the ambient sound in the environment outside the motor vehicle 2.

The evaluation unit 8 is configured to read in the input signal ES and vehicle operating data FBD. The vehicle operating data FBD may include an actuation signal from a direction of travel indicator, a gear or direction of travel selection, data from a navigation system and/or data from a driver assistance system.

In addition, the evaluation unit 8 is configured to evaluate the input signal ES and the vehicle operating data FBD in order to reproduce a three-dimensional sound map of the ambient sound in the environment outside the motor vehicle 2 in the interior of the motor vehicle 2. To this end, the evaluation unit 8 provides an output signal AS that can be used to actuate the loudspeaker assembly 10 in order to reproduce at least some of the three-dimensional sound map. In one embodiment, the loudspeaker assembly 10 is configured to use multiple loudspeakers in the interior of the motor vehicle 2 such as in the internal space thereof, in which the motor vehicle driver and possibly further passengers are situated, to reproduce a three-dimensional auditory impression. In this case, the three-dimensional sound image can be reproduced in a manner directed at the motor vehicle driver such that the loudspeaker assembly is actuated such that only the motor vehicle driver is provided with sound, while the other passengers in the interior of the motor vehicle are not provided with sound and are not therefore disturbed.

In the present exemplary embodiment, reproducing a three-dimensional auditory impression comprises a piece of direction information, such that a direction statement, concerning the direction from which the sound comes. In addition, in the present exemplary embodiment, the three-dimensional auditory impression comprises direction information obtained on the basis of the Doppler effect of a sound source. As such, it is possible to reproduce whether a road user is moving in a direction toward the motor vehicle 2 or away from it. Finally, in the present exemplary embodiment, the three-dimensional auditory impression comprises distance information obtained on the basis of a distance-dependent volume change for a sound source. As such, particularly close sound sources are reproduced particularly loudly, while particularly remote sound sources are reproduced particularly quietly. In particular, the sound from the respective sound sources can be reproduced at a volume that differs from the original volume. In other words, it is possible to model the three-dimensional sound map by modifying the volume so as to emphasize particularly relevant information.

Further, the evaluation unit 8 may be configured to reproduce only some areas of the three-dimensional sound map of the ambient sound in the environment outside the motor vehicle 2 in the interior of the motor vehicle 2. As such, a three-dimensional sound map of the ambient sound in the environment outside the motor vehicle can be reproduced in the interior of the motor vehicle 2 only when needed, such as, for example, when the traffic situation means that road users outside the field of vision or view of the motor vehicle driver are of particular significance to road safety. Otherwise, the three-dimensional sound image may not be reproduced. This may be the case when a direction of travel indicator has been operated. Accordingly, only the left or right component of the three-dimensional sound map of the ambient sound in the environment outside the motor vehicle 2 may be reproduced in the interior of the motor vehicle 2.

Alternatively or additionally, it is possible for only the rear component of the three-dimensional sound map of the ambient sound in the environment outside the motor vehicle 2 to be reproduced in the interior of the motor vehicle 2 when a reverse gear is selected, according to one embodiment.

Further, data from a navigation system can be taken into consideration. For example, it is thus possible to take into consideration that the road on which the motor vehicle 2 is moving crosses tram lines or that the motor vehicle 2 is moving on a multilane road, such as, for example, a freeway, or parallel to a cycle path, which means that road users in a blind spot can be expected in this situation. In addition, data from a driver assistance system can be taken into consideration. The driver assistance systems may be, for example: parking and reversing-out aids, lane change assistants, automatic distance alerts, lane departure alerts or systems for road sign recognition. Such driver assistance systems can be used to detect dangerous traffic situations and then to reproduce at least or only some of the three-dimensional sound map, particularly the sound map for that area of the three-dimensional sound map that is then of particular significance.

During operation, the sound capture device 4 captures the external sound ASS in the environment of the motor vehicle 2 and provides the input signal ES for the evaluation unit 8. Besides the input signal ES, the evaluation unit 8 also reads in the vehicle operating data FBD. By use of sensor data fusion, the evaluation unit 8 may determine whether there are road users in the surroundings of the motor vehicle 2, how great their distance from the motor vehicle 2 is, and whether they are moving away from the motor vehicle 2 or toward the motor vehicle 2. Further, the evaluation unit 8 evaluates the vehicle operating data FBD in order to determine a direction of travel of the motor vehicle 2, such as turning right or left, or traveling forward or backward, and whether there are particular hazard sources in the surroundings, such as, for example, tram lines or cycle paths crossing or intersecting the road. As such, it is possible to determine whether reproduction of the three-dimensional sound map is of particular significance in a particular area, such as a rear component when reversing, a left component when turning left and a right component when turning right. This respective component is reproduced using the loudspeaker assembly 10, while other components of the three-dimensional sound map are not reproduced. Further, the three-dimensional sound map is not reproduced if the determined direction of travel, such as traveling straight on, means that road users outside the field of vision or view of the motor vehicle driver cannot result in potentially dangerous traffic situations. As such, certain aspects of safety in road traffic can be maintained or increased.

The present disclosure provides for a motor vehicle having a sound capture device for the directionally dependent capture of external sound and providing an input signal representative of the external sound, an evaluation unit for evaluating the input signal and for providing an output signal representative of the input signal, and a loudspeaker assembly in the interior of the motor vehicle for outputting a sound signal consistent with the output signal. It thus becomes possible to use the loudspeaker assembly to reproduce a three-dimensional sound map of the ambient sound in the environment outside the motor vehicle in the interior of the motor vehicle. As such, a motor vehicle driver is provided with directionally reliable information about road users outside his field of vision or view, thereby potentially increasing road safety. In this case, the three-dimensional sound image could be reproduced in a manner directed at the motor vehicle driver, such that the loudspeaker assembly is actuated such that only the motor vehicle driver is provided with sound, while the other passengers in the interior of the motor vehicle are not provided with sound and are therefore not disturbed.

According to one embodiment, the sound capture device has a plurality of microphones. For example, there may be four microphones provided, of which one microphone is arranged in the front right-hand corner, one microphone is arranged in the front left-hand corner, one microphone is arranged in the rear right-hand corner and one microphone is arranged in the rear left-hand corner of the motor vehicle. Sound propagation time difference measurements using the individual microphones thus allow determination of the direction of the sound to be performed particularly easily.

According to a further embodiment, the evaluation unit is configured to output the output signal on the basis of vehicle operating data. This allows a three-dimensional sound map of the ambient sound in the environment outside the motor vehicle to be reproduced in the interior of the motor vehicle only when needed, such as when the traffic situation means that road users outside the field of vision or view of the motor vehicle driver are of particular significance to road safety. Otherwise, the three-dimensional sound image is not reproduced, according to one embodiment. As such, driving comfort is not adversely affected by unnecessary raising of the noise level in the interior of the motor vehicle.

According to a further embodiment, the vehicle operating data have an actuation signal from a direction of travel indicator. As such, an operated or triggered direction of travel indicator allows the conclusion to be drawn that the motor vehicle driver wants to turn either left or right. Accordingly, only the left or right component of the three-dimensional sound map of the ambient sound in the environment outside the motor vehicle may be reproduced in the interior of the motor vehicle.

According to a further embodiment, the vehicle operating data have a gear or direction of travel selection. For example, there may be provision for only the rear component of the three-dimensional sound map of the ambient sound in the environment outside the motor vehicle to be reproduced in the interior of the motor vehicle when a reverse gear is selected. If, by contrast, a gear for forward travel has been selected, the three-dimensional sound map is not reproduced, according to this embodiment.

According to a further embodiment, the vehicle operating data have data from a navigation system. As such, ambient data can be included in the decision regarding which portions of the three-dimensional sound map are reproduced. For example, it is thus possible to take into consideration that the road on which the motor vehicle is moving crosses tram lines or that the motor vehicle is moving on a multilane road, such as, for example, a freeway, or parallel to a cycle path, which means that road users in a blind spot can be expected in this case.

According to a further embodiment, the vehicle operating data have data from a driver assistance system. In this embodiment, driver assistance systems (Advanced Driver Assistance Systems), (ADAS) are understood to mean electronic supplementary devices in motor vehicles for assisting a motor vehicle driver in particular driving situations. These may be, for example, parking and reversing-out aids, lane change assistants, automatic distance alerts, lane departure alerts or systems for road sign recognition. When a dangerous traffic situation is detected by use of such a driver assistance system, it is then possible for at least some of the three-dimensional sound map to be reproduced, in particular those areas of the three-dimensional sound map that are then of particular significance.

According to a further embodiment, the evaluation unit is configured to evaluate the input signal in order to determine a distance of a sound source and to provide an output signal that leads to a sound signal having a volume consistent with the distance. As such, the motor vehicle driver can immediately be provided with perceptible information about the distance of other motor vehicles.

According to a further embodiment, the evaluation unit is configured to evaluate the input signal in order to determine a direction of movement of a sound source and to provide an output signal that leads to a sound signal consistent with the direction of movement. To this end, the Doppler effect is utilized and used to convey an applicable three-dimensional auditory impression. As such, the motor vehicle driver can immediately be provided with perceptible information about the direction of movement of other motor vehicles.

Further, the disclosure includes a sound capture device and an evaluation unit and also a computer program product.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A motor vehicle comprising:
a sound capture device for directionally dependent capture of external sound and providing an input signal representative of the external sound;
an evaluation unit for evaluating the input signal and for providing an output signal representative of the input signal; and
a loudspeaker assembly in an interior of the motor vehicle for outputting a sound signal consistent with the output signal.

2. The motor vehicle as claimed in claim 1, wherein the sound capture device comprises a plurality of microphones.

3. The motor vehicle as claimed in claim 1, wherein the evaluation unit is configured to output the output signal on the basis of vehicle operating data.

4. The motor vehicle as claimed in claim 3, wherein the vehicle operating data have an actuation signal from a direction of travel indicator.

5. The motor vehicle as claimed in claim 3, wherein the vehicle operating data have a gear selection or direction of travel selection.

6. The motor vehicle as claimed in claim 3, wherein the vehicle operating data have data from a navigation system.

7. The motor vehicle as claimed in claim 3, wherein the vehicle operating data have data from a driver assistance system.

8. The motor vehicle as claimed in claim 1, wherein the evaluation unit is configured to evaluate the input signal in order to determine a distance of a sound source and to provide an output signal that leads to a sound signal having a volume consistent with the distance.

9. The motor vehicle as claimed in claim 1, wherein the evaluation unit is configured to evaluate the input signal in order to determine a direction of movement of a sound source and to provide the output signal that leads to a sound signal consistent with a direction of movement.

10. A motor vehicle comprising:
a sound capture device capturing directionally dependent external sound;
an evaluation unit evaluating the captured external sound and providing an output signal representative of the captured external sound; and
a loudspeaker assembly in an interior of the motor vehicle for outputting a sound signal based on the output signal.

11. The motor vehicle as claimed in claim 10, wherein the sound capture device comprises a plurality of microphones.

12. The motor vehicle as claimed in claim 10, wherein the evaluation unit is configured to output the output signal on the basis of vehicle operating data.

13. The motor vehicle as claimed in claim 12, wherein the vehicle operating data have an actuation signal from a direction of travel indicator.

14. The motor vehicle as claimed in claim 12, wherein the vehicle operating data have a gear selection or direction of travel selection.

15. The motor vehicle as claimed in claim 12, wherein the vehicle operating data have data from a navigation system.

16. The motor vehicle as claimed in claim 12, wherein the vehicle operating data have data from a driver assistance system.

17. The motor vehicle as claimed in claim 10, wherein the evaluation unit is configured to evaluate an input signal representative of the captured external sound in order to determine a distance of a sound source and to provide an output signal that leads to a sound signal having a volume consistent with the distance.

18. The motor vehicle as claimed in claim 10, wherein the evaluation unit is configured to evaluate an input signal representative of the captured external sound in order to determine a direction of movement of a sound source and to provide the output signal that leads to a sound signal consistent with a direction of movement.

19. A sound system for a motor vehicle, comprising:
a sound capture device for capturing directionally dependent external sound and providing an input signal representative of the external sound;
an evaluation unit for evaluating the input signal and for providing an output signal representative of the input signal; and
a loudspeaker in an interior of the motor vehicle for outputting a directional sound signal consistent with the output signal.

20. The sound system for a motor vehicle as claimed in claim 19, wherein the sound capture device comprises a plurality of spaced apart microphones.
